(19) United States
(12) Patent Application Publication
(10) Pub. No.: US 2026/0075578 A1
(43) Pub. Date: Mar. 12, 2026

(54) INTEGRATED MONITORING APPARATUS AND METHOD FOR ABNORMAL SITUATIONS

(71) Applicant: Electronics and Telecommunications Research Institute, Daejeon (KR)

(72) Inventors: KICHEOUL WANG, Daejeon (KR); Tae Chul Hong, Daejeon (KR); Sung Chang Kim, Daejeon (KR); GEUN YONG KIM, Daejeon (KR); Ryangsoo Kim, Daejeon (KR); Jaein Kim, Daejeon (KR); Chorwon Kim, Daejeon (KR); HEE DO KIM, Daejeon (KR); Ji Hyoung Ryu, Daejeon (KR); Byung-Hee Son, Daejeon (KR); HARK YOO, Daejeon (KR); Giha YOON, Daejeon (KR)

(73) Assignee: Electronics and Telecommunications Research Institute, Daejeon (KR)

(21) Appl. No.: 19/321,956

(22) Filed: Sep. 8, 2025

(30) Foreign Application Priority Data
Sep. 11, 2024 (KR) 10-2024-0123623

(51) Int. Cl. H04W 64/00; H04W 4/029

(52) U.S. Cl. CPC H04W 64/006; H04W 4/029

(57) ABSTRACT

Provided is an integrated monitoring apparatus including: a communication module; and a processor functionally connected to the communication module, wherein the processor acquires connection information related to base station devices to which user terminals in a monitoring space are connected among a plurality of base station devices in the monitoring space through the communication module, identifies whether an abnormal movement flow occurs, based on a change in the connection information, and upon detecting an occurrence of the abnormal movement flow, verifies the abnormal movement flow based on a location of a target terminal related to the abnormal movement flow among the user terminals.

### CROSS-REFERENCE TO RELATED APPLICATION

This application claims priority to and the benefit of Korean Patent Application No. 10-2024-0123623, filed on Sep. 11, 2024, the disclosure of which is incorporated herein by reference in its entirety.

### BACKGROUND

### 1. Field of the Invention

Various embodiments disclosed in this document relate to a technology for monitoring an abnormal situation.

### 2. Discussion of Related Art

Closed-circuit television (CCTV) systems are installed in various environments such as inside and outside buildings and on roads and are used for various types of monitoring to prevent crimes and accidents. Conventional abnormal situation detection has a configuration in which managers monitor CCTV footage and perform subjective judgment to monitor abnormal situations. However, when the monitoring range is wide, it is difficult for managers to individually monitor CCTV footage.

Recently, artificial intelligence (AI)-based automation of abnormality monitoring has been implemented. For example, an AI-based abnormality monitoring apparatus measures the optical flow and the energy level distribution of people in sample CCTV footage, performs AI learning, and then determines an abnormal behavior based on those two characteristics in actual CCTV footage. In another example, technologies for identifying an abnormal behavior through sound information detected by a microphone attached to a CCTV and object tracking in CCTV footage have also been proposed.

Conventional abnormality monitoring devices may recognize an abnormal behavior in a crowd based on CCTV footage. Therefore, when there are blind spots in the CCTV footage or when there are occlusions and overlaps between people in the CCTV footage, the recognition accuracy significantly decreases.

### SUMMARY OF THE INVENTION

Various embodiments disclosed in this document may provide an integrated monitoring apparatus and method for an abnormal situation capable of monitoring an abnormal crowd movement flow based on wireless channel access information.

According to an aspect of the present invention, there is provided an integrated monitoring apparatus including: a communication module; and a processor functionally connected to the communication module, wherein the processor acquires connection information related to base station devices to which user terminals in a monitoring space are connected among a plurality of base station devices in the monitoring space through the communication module, identifies whether at least one abnormal situation from among an abnormal movement flow or an abnormal behavior of the user terminals occurs, based on a change in the connection information, and upon detecting an occurrence of the abnormal situation, determines whether to respond to the abnormal situation based on a location of a target terminal related to the occurrence of the abnormal situation among the user terminals.

According to an aspect of the present invention, there is provided a user terminal, which includes: a communication module; a memory storing instructions related to execution of a designated application; and a processor functionally connected to the memory, wherein the processor executes the instructions to allow the communication module to connect to at least one base station device among a plurality of base station devices within a monitoring space and block connection with other base station devices, and when an authentication code is transmitted to an external electronic device at an entrance to the monitoring space through the designated application, determine that the user terminal has entered the monitoring space.

According to an aspect of the present invention, there is provided an integrated monitoring method that is performed by at least one processor, which includes: acquiring connection information related to base station devices to which user terminals in a monitoring space are connected among a plurality of base station devices in the monitoring space; identifying whether at least one abnormal situation from among an abnormal movement flow or an abnormal behavior of the user terminals occurs, based on a change in the connection information; and upon detecting an occurrence of the abnormal situation, performing a response to the abnormal situation based on a location of a target terminal related to the occurrence of the abnormal situation among the user terminals.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an implementation environment of an integrated monitoring apparatus according to an embodiment;

FIG. 2 is a block diagram of an integrated monitoring apparatus according to an embodiment;

FIG. 3 is a schematic flowchart of an integrated monitoring method according to an embodiment;

FIG. 4 is a detailed flowchart of an integrated monitoring method according to an embodiment;

FIG. 5 is a flowchart of a method of acquiring an event authentication code according to an embodiment;

FIG. 6 is a flowchart of a method of monitoring connection information according to an embodiment;

FIG. 7 is a flowchart of a method of learning abnormal crowd situation detection according to an embodiment; and

FIG. 8 is a block diagram of a user terminal according to an embodiment of the present invention.

In relation to the description of the drawings, identical or similar reference numerals may be used for identical or similar components.

### DETAILED DESCRIPTION OF EXEMPLARY EMBODIMENTS

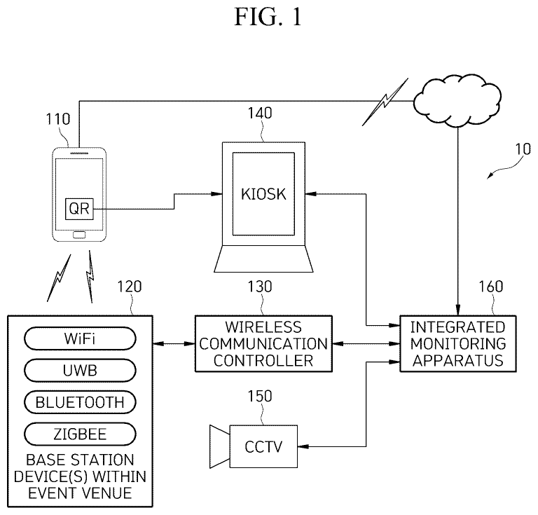

FIG. 1 is an implementation environment of an integrated monitoring apparatus according to an embodiment.

Referring to FIG. 1, an abnormal situation monitoring system 10 according to an embodiment may include a camera device 150, a plurality of base station devices 120, a wireless communication controller 130, a plurality of user terminals 110, an admission management device 140, and an integrated monitoring apparatus 160. In FIG. 1, a single user terminal is illustrated for convenience of description, but the present invention is not limited thereto. This document describes a case in which the integrated monitoring apparatus 160 monitors connection information of a plurality of user terminals to monitor an abnormal crowd situation.

The camera device 150 is provided to capture an image of a crowd in an event venue, and may capture an image of the inside of the event venue and transmit the captured monitoring image (CCTV footage) to the integrated monitoring apparatus 160. The camera device 150 may include at least one camera among, for example, a CCTV terminal, a black box camera, and a mobile camera (e.g., a drone or robot equipped with a camera).

According to an embodiment, the plurality of base station devices 120 may provide wireless communication channels to the user terminals 110 within the event venue. Each of the base station devices 120 may be a device that provides at least one wireless communication channel among, for example, Bluetooth, wireless fidelity (WiFi), ultra wideband (UWB), and ZigBee. The base station devices 120 may be devices related to data communication.

According to an embodiment, each base station device 120 may generate information according to a request from the wireless communication controller 130 or the integrated monitoring apparatus 160 and transmit the generated information to the wireless communication controller 130 or the integrated monitoring apparatus 160. For example, each base station device 120 may transmit terminal information (e.g., terminal IDs) related to user terminals 110 connected thereto according to a request from the wireless communication controller 130. As another example, each base station device 120 may calculate the location of the user terminals (e.g., 110) connected thereto according to a request of the integrated monitoring apparatus 160 to generate terminal location information and transmit the terminal location information to the integrated monitoring apparatus 160 via the wireless communication controller 130. The terminal location information may include, for example, a terminal ID, a base station ID, and terminal location coordinates.

According to an embodiment, the wireless communication controller 130 may control the plurality of base station devices 120 and transmit and receive data with the plurality of base station devices 120. For example, the wireless communication controller 130 may request the plurality of base station devices 120 to provide information on terminals connected to each of the plurality of base station devices 120, acquire the information, and generate connection information for the user terminals 110 connected to each base station device. The connection information may include, for example, a base station ID of each base station device, terminal IDs of the user terminals 110, and connection time information of the user terminals 110.

Each user terminal 110 is a mobile terminal used by a user and may include, for example, at least one of a smartphone, a mobile phone, a smart pad, and a wearable terminal.

According to an embodiment, a designated app (an event management app) may be installed on each user terminal 110. Each user terminal 110 may install the event management app through a pre-registration procedure with the integrated monitoring apparatus 160. The event management app may include, for example, a dedicated application (e.g., a movie theater application) related to issuing an admission ticket (or an authentication code (a QR code)) to an event venue (a monitoring area) or a general-purpose application (e.g., Explorer) that provides a site access function related to issuing admission tickets. The event venue may include, for example, a space with a high crowd density (e.g., an indoor space) such as an art gallery, a movie theater, a museum, or a concert hall.

According to an embodiment, each user terminal 110 may communicate with the integrated monitoring apparatus 160 through the designated event management app to perform user authentication and acquire and store an authentication code (an event venue admission ticket) related to entering the event venue. Each user terminal 110 may display the authentication code through the designated event management app according to a user's manipulation.

According to an embodiment, after entering the event venue, each user terminal 110 may wirelessly communicate using at least one of the plurality of base station devices 120 within the event venue. For example, each user terminal 110 may display (or transmit via proximity communication) an event venue admission ticket (QR code) on a designated event management app according to a user manipulation and confirm entry (admission) into the event venue through the admission management device 140. In this case, the designated application of each user terminal 110 may allow connection only with base station devices 120 within the event venue in relation to data communication, and block connection to other base station devices. However, voice calls may be permitted regardless of whether the base station devices are outside the event venue.

According to an embodiment, the admission management device 140 may confirm each user's admission into the event venue based on an authentication code (e.g., an admission ticket QR code) from each user terminal 110. For example, the admission management device 140 is a kiosk, and may recognize the authentication code displayed on each user terminal 110 through an authentication code (QR code) reader (e.g., a camera or a proximity communication module), and confirm (or recognize) the user's event venue admission based on the QR code.

According to an embodiment, the admission management device 140 may, upon confirming each user's event venue admission, transmit admission notification information including admission time information and an authentication code to the integrated monitoring apparatus 160.

According to an embodiment, the integrated monitoring apparatus 160 may register and manage the user's event venue admission. For example, when the integrated monitoring apparatus 160 acquires an event participation request from each user terminal 110, the integrated monitoring apparatus 160 may provide an event management app. The integrated monitoring apparatus 160 may perform user authentication through the event management app and provide an authentication code (e.g., a QR code) corresponding to an event venue admission ticket to each user terminal 110. Through the user authentication, the integrated monitoring apparatus 160 may register and store personal information and contact information of the user to whom the event venue admission ticket has been issued.

According to an embodiment, the integrated monitoring apparatus 160 may receive admission notification information related to each user terminal 110 that has entered the event venue from the admission management device 140. When the integrated monitoring apparatus 160 receives the admission notification information, the integrated monitoring apparatus 160 may generate and store admission history information of each user terminal 110. The admission history information may include, for example, admission time information and terminal information (e.g., a terminal ID) of the user terminal.

According to an embodiment, the integrated monitoring apparatus 160 may roughly track the number of terminals connected to each base station device, and the movement direction and the movement speed of each user terminal 110 using a change in the connection information. For example, the integrated monitoring apparatus 160 may calculate the number of terminals connected to each base station device based on the base station device ID in the connection information. As another example, the integrated monitoring apparatus 160 may identify changes in the base station device to which a terminal is connected and the rate of the changes on the basis of changes in the base station device ID and a connection start time (connection time information) in the connection information. The integrated monitoring apparatus 160 may calculate the movement direction and movement speed based on the changes in the connected base station device and the rate of the changes.

According to an embodiment, the integrated monitoring apparatus 160 may detect an abnormal crowd movement flow within the event venue based on the change in the connection information. For example, the integrated monitoring apparatus 160 may identify whether the movement of the user terminals 110 corresponds to an abnormal crowd movement flow based on the change in the connection information. The integrated monitoring apparatus 160 may identify whether the movement corresponds to at least one abnormal crowd movement flow from among a situation in which the number of user terminals moving at a speed greater than or equal to a threshold speed in the same direction is a first reference value or more or a situation in which there are overcrowded base station devices among the base station devices 120. The threshold speed and the first reference value may be set to the maximum speed and the maximum number of people at which safe movement within the event venue can be ensured. The overcrowded base station device may be, for example, a base station device to which terminals (user terminals) that satisfy a second reference value or more are connected. The second reference value may be determined as, for example, the maximum number of people that may be present within a unit area of the event venue.

In this regard, when the wireless communication controller 130 receives, from each base station device 120, connection information of the user terminals 110 connected thereto, the wireless communication controller 130 may transmit the received connection information to the integrated monitoring apparatus 160 periodically or when a change occurs. Accordingly, the integrated monitoring apparatus 160 may receive the connection information of each user terminal 110.

According to an embodiment, the integrated monitoring apparatus 160 may, upon detecting at least one abnormal situation among an abnormal movement flow or an abnormal behavior based on a change in connection information, select target user terminals (hereinafter referred to as “target terminals”) related to the abnormal situation. For example, the integrated monitoring apparatus 160 may select user terminals 110 connected to a crowded base station device as target terminals. Alternatively, the integrated monitoring apparatus 160 may select user terminals moving in the same direction at a speed greater than or equal to a threshold speed as target terminals.

According to an embodiment, the integrated monitoring apparatus 160 may track the location of the target terminal related to the abnormal movement flow. For example, the integrated monitoring apparatus 160 may request location information of the target terminal from a base station device to which the target terminal is connected and a neighboring base station device (e.g., 120) adjacent thereto through the wireless communication controller 130. The connected base station device and the neighboring base station device (e.g., 120), upon acquiring a location information request, may identify target terminal information (e.g., a terminal ID) and calculate terminal location information of the corresponding target terminal. The connected base station device and the neighboring base station device 120 may transmit the terminal location information to the integrated monitoring apparatus 160, and the integrated monitoring apparatus 160 may receive the terminal location information through the wireless communication controller 130.

According to an embodiment, the integrated monitoring apparatus 160 may identify whether an actual abnormal situation has occurred in a target area based on the location of the target terminal. For example, the integrated monitoring apparatus 160 may recheck the density of the target area (e.g., the number of people in a unit area) based on the location of the target terminal. The integrated monitoring apparatus 160 may determine that an abnormal situation has occurred in the target area when the density of the target area is a threshold density or more. The threshold density may be, for example, a density corresponding to a situation in which people according to a second reference value are present in the unit area.

According to an embodiment, the integrated monitoring apparatus 160 may, upon detecting the occurrence of an abnormal situation in the target area, calculate the risk level of the abnormal situation. For example, the integrated monitoring apparatus 160 may determine that the risk level is severe when the density of the target area is greater than a threshold density for a second threshold time or longer. As another example, the integrated monitoring apparatus 160 may determine that the risk level is moderate when the time for which the density of the target area is greater than the threshold density is less than the second threshold time. The second threshold time may be set as a statistical time in which the risk of a safety accident increases due to the threshold density.

According to an embodiment, the integrated monitoring apparatus 160 may output a response command related to the abnormal situation according to the risk level of the abnormal situation. For example, the integrated monitoring apparatus 160 may continue to track the location of the target terminal when the risk level of the abnormal situation is moderate. As another example, the integrated monitoring apparatus 160 may instruct the deployment of crowd control personnel when the risk level of the abnormal situation is severe. The integrated monitoring apparatus 160 may transmit a response command to, for example, at least one user terminal of the crowd control personnel (e.g., a crowd control supervisor terminal) to recommend the deployment of crowd control personnel. As another example, the integrated monitoring apparatus 160 may output a response command that instructs the opening of a closed entrance around the target area and the deployment of a safety officer (crowd control personnel).

According to an embodiment, the integrated monitoring apparatus 160 may identify the motion of an individual object based on joint information of an object in the monitoring image (e.g., CCTV footage) and detect the occurrence of an abnormal behavior based on the motion of the individual object. The integrated monitoring apparatus 160 may, upon detecting the occurrence of an abnormal behavior, output a response command related to the occurrence of the abnormal behavior. In this case, the integrated monitoring apparatus 160 may output a response command that instructs at least one of the opening of a closed entrance around the target area in which the abnormal behavior occurred and the deployment of a safety officer (crowd control personnel).

According to an embodiment, the integrated monitoring apparatus 160 may further analyze a crowd flow based on the monitoring image from the camera device 150. The integrated monitoring apparatus 160 may detect objects (e.g., people) in monitoring image frames, and calculate a crowd flow (e.g., a movement direction and a movement speed) based on the movement (e.g., an optical flow) of the detected objects (e.g., people). In addition, the integrated monitoring apparatus 160 may monitor whether an individual object is in an abnormal situation based on the crowd movement flow. However, when there are an excessive number of people in the monitoring image, causing significant overlaps between people, an error may occur in analyzing the crowd flow. Therefore, the integrated monitoring apparatus 160 may analyze the crowd flow using both changes in connection information and changes in movement of the monitoring image.

According to an embodiment, the integrated monitoring apparatus 160 may store the monitoring image and the change in connection information corresponding to the time of occurrence of the abnormal situation, and data on results of abnormal situation confirmation. Thereafter, the integrated monitoring apparatus 160 may periodically learn at least one of detection of abnormal movement flow or detection of an abnormal behavior using the monitoring image and the change in connection information corresponding to the time of occurrence of the abnormal situation, and the data on the results of abnormal situation confirmation. The integrated monitoring apparatus 160 may update an artificial intelligence model that detects the abnormal movement flow or the abnormal behavior based on the result of learning.

As described above, the integrated monitoring apparatus 160 according to an embodiment recognizes the abnormal behavior and the abnormal movement flow in the crowd by integrating CCTV footage and changes in connection information, and performs analysis and learning on CCTV footage, changes in connection information, and the result of confirmation of the abnormal behavior or abnormal movement flow using an artificial intelligence model, thereby providing recognition accuracy of abnormal crowd behavior and flow that is higher than that of a conventional method using only images.

In addition, the integrated monitoring apparatus 160 according to an embodiment may identify the locations of user terminals 110 for a which an abnormal behavior or abnormal movement flow in a crowd is recognized, classify the risk of the abnormal behavior or flow, and respond to an area in which the abnormal behavior or flow has occurred (deploying crowd control personnel or opening an exit) according to the risk, thereby reducing the risk of an accident.

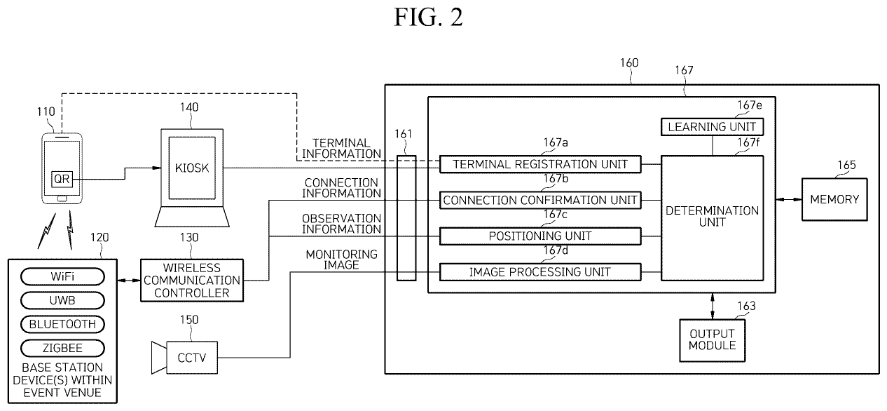

FIG. 2 is a block diagram of an integrated monitoring apparatus according to an embodiment.

Referring to FIG. 2, the integrated monitoring apparatus 160 according to an embodiment may include an output module 163, a communication module 161, a memory 165, and a processor 167. In one embodiment, in the integrated monitoring apparatus 160, some components may be omitted or additional components may be added. In addition, some of the components of the integrated monitoring apparatus 160 may be combined to form a single component, but may perform the same functions of the components before the combination.

The output module 163 may visually or audibly output data related to at least one of symbols, numbers, or characters under the control of the processor 167. The output module 163 may include, for example, at least one output device among a liquid crystal display, an organic light emitting diode (OLED), a touch screen display, and a speaker.

The communication module 161 may support the establishment of a communication channel or a wireless communication channel between the integrated monitoring apparatus 160 and another device (e.g., a user terminal 110, a camera device 150, or a wireless communication controller 130), and the performance of communication through the established communication channel. The communication channel may include, for example, at least one of a local area network (LAN), fiber to the home (FTTH), a digital subscriber line (xDSL), wireless broadband (WiBro), a wireless LAN, WiFi, Bluetooth, ZigBee, Wi-Fi Direct (WFD), ultra wideband (UWB), Infrared Data Association (IrDA), Bluetooth Low Energy (BLE), near field communication (NFC), 3G, 4G, 5G or 6G. The communication module 161 may perform communication using known communication methods such as code division multiple access (CDMA), Global System for Mobile Communications (GSM), W-CDMA, time division-synchronous code division multiple access (TD-SCDMA), WiBro, Long Term Evolution (LTE), Evolved Packet Core (EPC), etc.

The memory 165 may include various types of volatile memories or nonvolatile memories. For example, the memory 165 may include a read only memory (ROM) and a random access memory (RAM). In an embodiment, the memory 165 may be located inside or outside the processor 167, and the memory 165 may be connected to the processor 167 through various known means. The memory 165 may store various types of data used by at least one component of the integrated monitoring apparatus 160 (e.g., the processor 167). The data may include, for example, input data or output data for software and instructions related thereto. For example, the memory 165 may store at least one instruction and data for detecting an abnormal crowd movement flow and an abnormal situation/behavior.

The processor 167 may control at least one other component (e.g., a hardware or software component) of the integrated monitoring apparatus 160 and may perform various data processing processes or calculations. The processor 167 may include, for example, at least one of a central processing unit (CPU), a graphics processing unit (GPU), a microprocessor, an application processor, an application specific integrated circuit (ASIC), and a field programmable gate array (FPGA), and may have a plurality of cores.

According to an embodiment, the processor 167 may acquire connection information related to base station devices to which user terminals in the monitoring space are connected among a plurality of base station devices in the monitoring space through the communication module 161. The processor 167 may identify whether there is an abnormal movement flow of the user terminals based on a change in the connection information. When the abnormal movement flow is detected, the processor 167 may identify the risk of the abnormal movement flow based on the location of target terminals related to the abnormal movement flow among the user terminals.

According to an embodiment, the processor 167 may communicate with another electronic device, for example, the plurality of user terminals 110, the wireless communication controller 130, the admission management device 140, or the camera device 150, through the communication module 161. The processor 167 may acquire admission history information from the admission management device 140. The processor 167 may calculate actual location information of the target terminal from an approximate location of the target terminal identified by the base station devices 120 connected to the wireless communication controller 130. The processor 167 may acquire monitoring images from the camera device 150.

According to an embodiment, the processor 167 may include a terminal registration unit 167A, a connection confirmation unit 167B, a positioning unit 167C, an image processing unit 167D, a learning unit 167E, and a determination unit 167F. The terminal registration unit 167A, the connection confirmation unit 167B, the positioning unit 167C, the image processing unit 167D, the learning unit 167E, and the determination unit 167F may be software/hardware modules included in or controlled by the processor 167, or software modules executed by the processor 167. Therefore, the execution of the terminal registration unit 167A, the connection confirmation unit 167B, the positioning unit 167C, the image processing unit 167D, the learning unit 167E, and the determination unit 167F may be described based on the processor 167.

The terminal registration unit 167A may perform user authentication of user terminals 110 that have requested to participate in an event venue within a monitoring space and provide an event management app to each of the user terminals 110. The terminal registration unit 167A may perform user authentication through the event venue management app and provide an authentication code (e.g., a QR code) corresponding to an event venue admission ticket to each user terminal 110. The terminal registration unit 167A may register and store personal information and contact information of the user for whom the authentication code has been issued.

According to an embodiment, the terminal registration unit 167A may receive admission notification information related to each user terminal 110 that has entered the event venue from the admission management device 140 through the communication module 161. When the terminal registration unit 167A receives the admission notification information, the terminal registration unit 167A may generate and store admission history information of each user terminal 110. The admission history information may include, for example, admission time information and user terminal information (e.g., a phone number and a terminal ID).

According to an embodiment, the connection confirmation unit 167B may acquire connection information related to a base station device to which the user terminals 110 in the monitoring space are connected from the wireless communication controller 130 through the communication module 161. The connection information may include, for example, a base station ID of each base station device, terminal IDs of the user terminals 110, and connection time information of the user terminals 110. In this regard, the wireless communication controller 130 may acquire connection information related to user terminals connected to each base station device from a plurality of base station devices 120 and provide the connection information to the connection confirmation unit 167B.

According to an embodiment, the connection confirmation unit 167B may roughly track the number of terminals connected to each base station device, the movement direction, and the movement speed of each user terminal 110 using a change in the connection information. For example, the connection confirmation unit 167B may calculate the number of terminals connected to each base station device based on the base station device ID in the connection information. As another example, the connection confirmation unit 167B may identify changes in a base station device to which a terminal is connected and the rate of the changes on the basis of changes in the base station device ID and a connection start time (connection time information) in the connection information. The connection confirmation unit 167B may calculate the movement direction and the movement speed based on the changes in the connected base station device and the rate of the changes. As another example, the connection confirmation unit 167B may confirm, based on the connection information, a user terminal connected to only a single base station device among the user terminals for a first threshold time or longer, the distance between people in the crowd, the number of terminals connected to each base station device, a user terminal present in a designated dangerous area, and a user terminal adjacent to an entrance.

According to an embodiment, the determination unit 167F may detect an abnormal crowd movement flow within the event venue based on the change in the connection information. For example, the determination unit 167F may identify whether the movement of the user terminals 110 corresponds to an abnormal crowd movement flow based on the change in the connection information. For example, the determination unit 167F may identify whether the movement corresponds to at least one abnormal crowd movement flow among a situation in which the number of user terminals moving at a speed greater than or equal to a threshold speed is a first reference value or more, or a situation in which there are overcrowded base station devices among the base station devices 120. The threshold speed and the first reference value may be set to the maximum speed and the maximum number of people at which safe movement within the event venue can be ensured. The overcrowded base station device may be, for example, a base station device to which terminals (user terminals) more than or equal to a second reference value are connected. The second reference value may be determined as, for example, the maximum number of people that may be present within a unit area of the event venue.

According to an embodiment, when an abnormal movement flow is detected, the positioning unit 167C may track the locations of target user terminals (hereinafter referred to as “target terminals”) present in a target area corresponding to the abnormal movement flow. For example, the positioning unit 167C may request terminal location information of the target terminal from neighboring base station devices of the target terminal through the wireless communication controller 130. The positioning unit 167C may receive terminal location information calculated by the neighboring base station devices. The positioning unit 167C may determine the location of the target terminal by integrating the received terminal location information. The positioning unit 167C may receive terminal location information a, b, and c from, for example, three neighboring base station devices A, B, and C respectively. The positioning unit 167C may determine a common portion location of each terminal location information a, b, and c as the location of the target terminal.

According to an embodiment, the determination unit 167F may identify whether there is an actual abnormal situation in the target area based on the location of the target terminal. For example, the determination unit 167F may identify the density of the target area (e.g., the number of people in a unit area) based on the location of the target terminal. When the density of the target area is a threshold density or more, the determination unit 167F may determine that an abnormal situation has occurred in the target area. The threshold density may be, for example, a density corresponding to a situation in which people according to a second reference value are present in the unit area.

According to an embodiment, the determination unit 167F may, upon determining that an abnormal situation has occurred in the target area, calculate the risk level of the abnormal situation. For example, in a situation in which the density of the target area is the threshold density or more for a second threshold time or longer, the determination unit 167F may determine that the risk is at a severe level. As another example, when the time in which the density of the target area is the threshold density or more is less than or equal to the second threshold time period, the determination unit 167F may determine that the risk is at a moderate level. The above second threshold time may be set as a statistical time when the risk of a safety accident increases due to the threshold density.

According to an embodiment, the determination unit 167F may detect an abnormal crowd behavior, including cases in which there is no or little movement of user terminals within the event venue, based on changes in connection information. For example, the determination unit 167F may detect, through the positioning unit 167C, the abnormal crowd behavior, for example, a crowd armed conflict state, an injury occurrence state, a dense state of dangerous areas, or an abnormal behavior near an entrance or exit.

According to one embodiment, when the determination unit 167F identifies that user terminals (hereinafter, “monitoring target terminals”) more than or equal to a first threshold number are connected to only a single base station device for a first threshold time or more based on changes in connection information, the determination unit 167F may detect the locations of the monitoring target terminals through the positioning unit 167C. Thereafter, the determination unit 167F may detect an abnormal crowd behavior based on the locations of the detected monitoring target terminals.

For example, the determination unit 167F may determine that a crowd violence behavior related to the monitoring target terminals has occurred when the distance between the monitoring target terminals is within a threshold distance and the locations of the monitoring target terminals change rapidly. As another example, the determination unit 167F may determine that a state of injury has occurred (e.g., a state in which some in the crowd have fallen and is not moving) when there is no change in the locations of some of the monitoring target terminals. As another example, the determination unit 167F may determine that a crowd congestion state in dangerous areas related to the monitoring target terminals (e.g., a state in which a crowd is gathering in an area at risk of collapse) has occurred when the number of terminals connected to a single base station device continuously increases, the changes in the locations of the monitoring target terminals are less than a threshold change rate (or are insignificant or nonexistent), and the monitoring target terminals are adjacent to a collapse risk area (e.g., a wire mesh fence, a ventilation shaft).

According to one embodiment, the determination unit 167F may continuously track terminal location information for user terminals connected to a base station device near an entrance (or an emergency exit) among the base station devices 120 through the positioning unit 167C. The determination unit 167F may determine that an abnormal behavior adjacent to an entrance (or emergency exit) (e.g., loading an object into an entrance or emergency exit within a building) has occurred when a pattern of a plurality of people (a plurality of user terminals) approaching an entrance (or emergency exit) and then moving away from the entrance (or emergency exit) within a third threshold time (a short time) is repeated based on terminal location information.

According to an embodiment, the processor 167 may output a response command related to the abnormal situation through the output module 163 according to the risk level of the abnormal situation. For example, when the risk level of the abnormal situation is at a moderate level, the processor 167 may continue to track the location of the target terminal. As another example, when the risk level of the abnormal situation is at a severe level, the processor 167 may instruct the deployment of crowd control personnel through the output module 163 (e.g., a display or a speaker). The processor 167 may transmit a response command recommending the deployment of crowd control personnel to at least one user terminal of the crowd control personnel (e.g., the crowd control officer terminal) through the communication module 161, for example. As another example, the processor 167 may output a response command instructing the opening of closed entrances and the deployment of safety personnel (crowd control personnel) around the target area through the output module 163.

According to an embodiment, the image processing unit 167D may analyze the movement flow of the crowd based on the monitoring image. The image processing unit 167D may detect an object (e.g., a person) in monitoring image frames, and calculate a crowd movement flow (e.g., a movement direction and a movement speed) based on a movement (e.g., an optical flow) of the detected object (e.g., a person). In this case, the determination unit 167F may detect an abnormal crowd movement flow based on the output of the image processing unit 167D and the change in the connection information. In addition, the determination unit 167F may monitor whether an individual object is in an abnormal state based on the crowd movement flow. However, when there are an excessive number of people in the monitoring image, causing significant overlaps between people, an error may occur in analyzing the crowd flow. Therefore, the determination unit 167F may analyze the crowd flow using changes in connection information and changes in movement of the monitoring image.

According to an embodiment, the image processing unit 167D may identify the movement of an individual object based on joint information of an object in the monitoring image. The determination unit 167F may determine the occurrence of an abnormal behavior based on the movement of the individual object.

According to an embodiment, the processor 167 may, upon detecting the occurrence of an abnormal behavior, output a response command related to the occurrence of the abnormal behavior. In this case, the processor 167 may output a response command that instructs at least one of the opening of a closed entrance around the target area in which the abnormal behavior occurred and the deploying of a safety officer (crowd control personnel).

According to an embodiment, the processor 167 may store the monitoring image and the change in connection information corresponding to the time of occurrence of the abnormal situation, and data on results of abnormal situation confirmation. Thereafter, the learning unit 167E may periodically learn at least one of detection of abnormal movement flow or detection of occurrence of an abnormal situation using the monitoring image and the change in connection information corresponding to the time of occurrence of the abnormal situation, and the data on the results of the abnormal situation confirmation. The learning unit 167E may update an artificial intelligence model (determination unit 167F) that detects the abnormal movement flow and occurrence of an abnormal behavior based on the results of learning.

As described above, the integrated monitoring apparatus 160 according to an embodiment performs analysis and learning on the images corresponding to the time of occurrence of the abnormal situation, the change connection information, and the abnormal situation confirmation result using the artificial intelligence model, thereby providing recognition accuracy of the abnormal crowd behavior and flow that is higher than that of the conventional method using only images.

In addition, the integrated monitoring apparatus 160 according to an embodiment may use the change in the crowd's connection information collected from the wireless communication network installed in the monitoring area and the CCTV footage together to improve the detection accuracy of an abnormal crowd behavior (sudden changes in crowd movement speed, continuous accumulation of crowd stopping in a specific area, etc.) and abnormal movement flow (a crowd rushing to an entrance, some in a crowd rushing in the opposite direction of the majority of the crowd, etc.) in areas in which monitoring based on images is difficult due to CCTV blind spots or crowd density, based on the connection information or location information.

In addition, the integrated monitoring apparatus 160 according to an embodiment may confirm the location of user terminals 110 for which abnormal crowd behavior or abnormal movement flow is recognized, classify the risk of the abnormal behavior or flow based on the location, and take a proper action (deploying crowd control personnel or opening an entrance) according to the risk, thereby reducing the risk of an accident.

Furthermore, the integrated monitoring apparatus 160 according to an embodiment stores images corresponding to the time of occurrence of an abnormal situation, changes in connection information, and abnormal situation confirmation results, and periodically trains an artificial intelligence model that use the images corresponding to the time of occurrence of an abnormal situation, the changes in connection information, and the abnormal situation confirmation results as inputs to increase the accuracy of determination of an abnormal behavior and abnormal movement flow in the future.

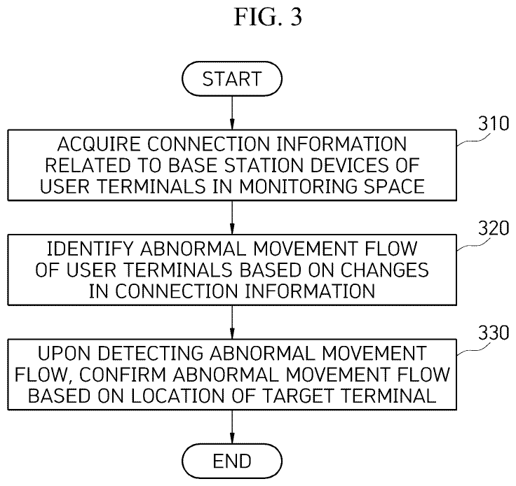

FIG. 3 is a schematic flowchart of an integrated monitoring method according to an embodiment.

Referring to FIG. 3, in operation 310, the integrated monitoring apparatus 160 may acquire connection information related to base station devices 120 to which user terminals 110 in a monitoring space are connected among a plurality of base station devices in the monitoring space.

In operation 320, the integrated monitoring apparatus 160 may identify whether there is an abnormal movement flow of the user terminals 110 based on changes in the connection information.

In operation 330, the integrated monitoring apparatus 160 may, upon detecting an abnormal movement flow, identify the risk level of the abnormal movement flow based on a location of a target terminal related to the abnormal movement flow among the user terminals 110.

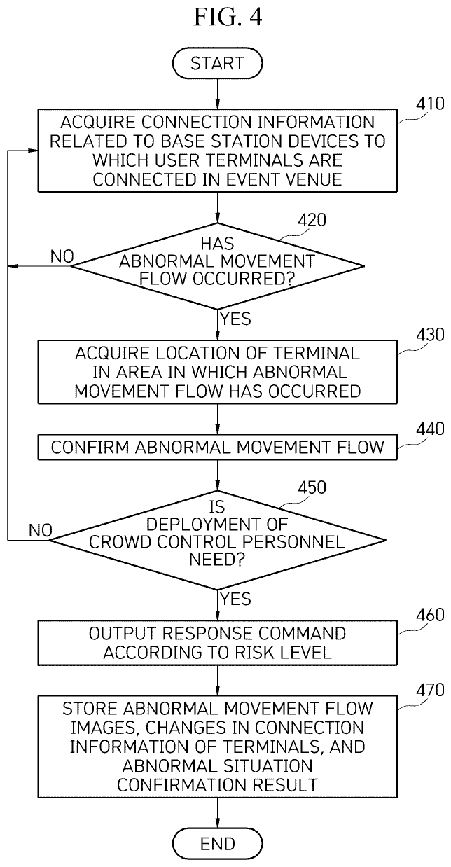

FIG. 4 is a detailed flowchart of an integrated monitoring method according to an embodiment.

Referring to FIG. 4, in operation 410, the integrated monitoring apparatus 160 may acquire connection information related to user terminals 110 connected to a plurality of base station devices 120 in the event venue.

In operation 420, the integrated monitoring apparatus 160 may identify whether there is an abnormal movement flow of user terminals 110 based on changes in the connection information. For example, the integrated monitoring apparatus 160 may identify whether the situation corresponds to at least one of: a situation in which there are users greater than a first reference value who move in the same direction and the movement speed is greater than a threshold speed; or a situation in which there is an overcrowded base station device among the base station devices 120.

In operation 430, the integrated monitoring apparatus 160 may, upon identifying that there is an abnormal movement flow, identify the location of a target terminal related to the abnormal movement flow among the user terminals 110. For example, the integrated monitoring apparatus 160 may request terminal location information of the target terminals from an overcrowded base station device and neighboring base station devices adjacent thereto. Thereafter, the integrated monitoring apparatus 160 may acquire the terminal location information of each of the user terminals connected to the overcrowded base station device and the neighboring base station devices and detect detailed locations of the target terminals based on the acquired terminal location information.

In operation 440, the integrated monitoring apparatus 160 may identify the risk level of the abnormal movement flow based on the locations of the target terminals. For example, the integrated monitoring apparatus 160 may identify the density of a target area based on the locations of the target terminals, and when the density is higher than a threshold density, may determine that an abnormal movement flow is present.

In operation 450, the integrated monitoring apparatus 160 may, upon identifying the abnormal movement flow, identify whether deployment of crowd control personnel is needed based on the risk level. For example, the integrated monitoring apparatus 160 may, when the time for which the density of the target area is greater than a threshold density is longer than or equal to a threshold time, determine that the risk level is severe and that it is a situation requiring the deployment of crowd control personnel. As another example, the integrated monitoring apparatus 160 may, when the time for which the density of the target area is greater than the critical density is less than the threshold time, determine that the risk level is moderate. The threshold time may be set as a statistical time in which the risk of a safety accident increases due to the threshold density.

In operation 460, the integrated monitoring apparatus 160 may output a response command according to the risk level. For example, when the risk level of the abnormal situation is severe, the integrated monitoring apparatus 160 may instruct the opening of closed entrances around the target area and the deployment of crowd control personnel. As another example, when the risk level of the abnormal situation is moderate, the integrated monitoring apparatus 160 may output a safety warning through a speaker and continue to track the location of the target terminal.

In operation 470, the integrated monitoring apparatus 160 may store and learn monitoring images corresponding to the time of the occurrence of the abnormal movement flow, changes in connection information of terminals, and data on results of abnormal situation confirmation (e.g., results confirmed by crowd control personnel). For example, the integrated monitoring apparatus 160 may perform abnormal situation detection based on changes in connection information, changes in a movement flow in monitoring images, and changes in movement by object using an artificial intelligence model, and store the abnormal situation confirmation results in the memory 165 together with the images corresponding to the time of the occurrence of the abnormal movement flow and the changes in connection information.

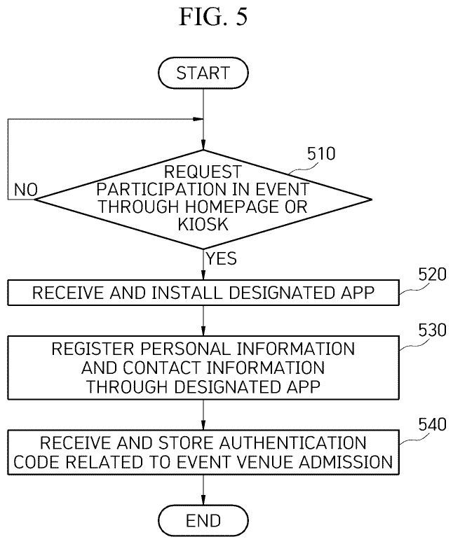

FIG. 5 is a flowchart of a method of acquiring an event authentication code according to an embodiment.

Referring to FIG. 5, in operation 510, each user terminal 110 may request participation in an event through a designated homepage or kiosk. The designated homepage may be a website provided by the event organizer. The kiosk may be a terminal installed at the entrance (or an access point) of the event venue that manages admission into the event venue.

In operation 520, each user terminal 110 may receive and install a designated app (an event management app) from a webpage accessed through the designated homepage or kiosk.

In operation 530, each user terminal 110 may register the user's personal information and contact information in the integrated monitoring apparatus 160 through the designated app.

In operation 540, each user terminal 110 may receive an authentication code related to event venue admission from the integrated monitoring apparatus 160 and store the received authentication code.

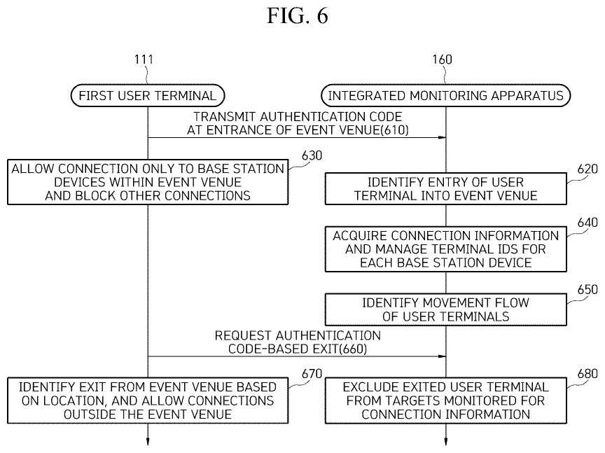

FIG. 6 is a flowchart of a method of monitoring connection information according to an embodiment.

Referring to FIG. 6, in operation 610, a first user terminal 111 may transmit an authentication code to the integrated monitoring apparatus 160 through the admission management device 140 at the entrance of the event venue.

In operation 620, the integrated monitoring apparatus 160 may identify the entry of the first user terminal 111 into the event venue and select the first user terminal 111 as a connection information monitoring target.

In operation 630, after transmitting the authentication code, the first user terminal 111 may connect only to base station devices within the event venue for at least data communication related to a wireless communication channel and block other connections.

In operation 640, the integrated monitoring apparatus 160 may acquire connection information for user terminals 110 within the event venue and manage terminal IDs for each base station device.

In operation 650, the integrated monitoring apparatus 160 may identify a movement flow of the user terminals 110 based on changes in the base station device associated with each terminal ID in the connection information.

As shown in operation 660, the first user terminal 111 may transmit an exit request based on an authentication code or a designated app according to a user's manipulation. In operation 670, the event management app installed in the first user terminal 111 may identify the exit from the event venue based on the location of the user terminal and allow connections to base station devices outside the event venue.

In operation 680, the integrated monitoring apparatus 160 may exclude the first user terminal 111 from the targets monitored for changes in connection information.

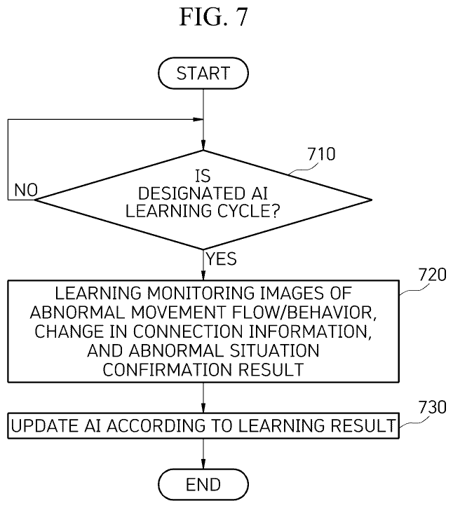

FIG. 7 is a flowchart of a method of learning crowd abnormality detection according to an embodiment.

Referring to FIG. 7, in operation 710, the integrated monitoring apparatus 160 may identify whether it is a designated AI learning cycle.

In operation 720, the integrated monitoring apparatus 160 may load monitoring images corresponding to the time of occurrence of the abnormal movement flow/abnormal behavior, the change in connection information, and abnormal situation confirmation results, which are previously stored, and train the artificial intelligence model (the determination unit 167F). For example, the integrated monitoring apparatus 160 may perform detection and response to the abnormal movement flow using the artificial intelligence model by learning the monitoring images corresponding to the time of occurrence of the abnormal movement flow, the change in connection information of the terminals, and the abnormal situation confirmation result.

In operation 730, the integrated monitoring apparatus 160 may update the artificial intelligence model (the determination unit 167F) according to the result of the learning.

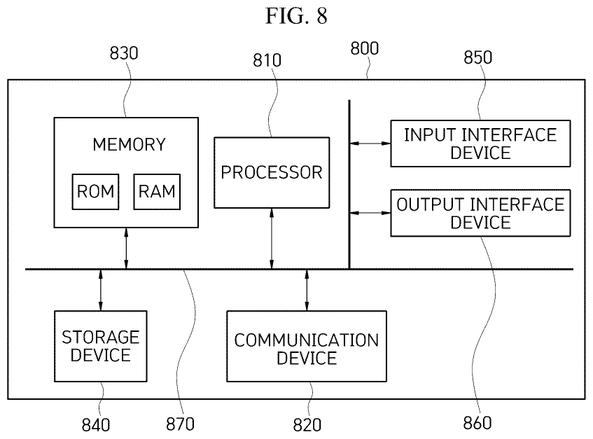

FIG. 8 is a block diagram of a user terminal according to an embodiment of the present invention.

Referring to FIG. 8, the computer system 800 may include at least one of a processor 810, a memory 830, an input interface device 850, an output interface device 860, and a storage device 840 that perform communication through a bus 870. The computer system 800 may further include a communication device 820 coupled to a network. The processor 810 may be a central processing unit (CPU) or a semiconductor device for executing instructions stored in the memory 830 and/or storage device 840. The memory 830 and the storage device 840 may include various forms of volatile or nonvolatile media. For example, the memory 830 may include a ROM or a RAM. In an embodiment of the present invention, the memory 830 may be located inside or outside the processor 810 and may be connected to the processor 810 through various known means. The memory 830 may include various forms of volatile or nonvolatile media. For example, it may include a ROM or a RAM.

The various embodiments of the disclosure and terminology used herein are not intended to limit the technical features of the disclosure to the specific embodiments, but rather should be understood to cover all modifications, equivalents, and alternatives falling within the spirit and scope of the invention. Like numbers refer to like elements throughout the description of the drawings. The singular forms preceded by “a” and “an” corresponding to an item are intended to include the plural forms as well unless the context clearly indicates otherwise. In the disclosure, phrases such as “A or B,” “at least one of A and B,” “at least one of A or B,” “A, B or C,” “at least one of A, B and C,” and “at least one of A, B, or C” may include any one of the items listed together in the corresponding phrase, or any possible combination thereof. Terms such as “first,” “second,” etc., are used to distinguish one element from another and do not modify the elements in other aspects (e.g., importance or sequence). When one (e.g., a first) element is referred to as being “coupled” or “connected” to another (e.g., a second) element with or without the term “functionally” or “communicatively,” it means that the one element is connected to the other element directly (e.g., by wire), wirelessly, or via a third element.

As used herein, the term “module” may include units implemented in hardware, software, or firmware, and may be interchangeably used with terms such as “logic,” “logic block,” “component,” or “circuit.” The module may be an integrally configured component or a minimum unit or part of the integrally configured component that performs one or more functions. For example, according to one embodiment, the module may be implemented in the form of an application-specific integrated circuit (ASIC).

The various embodiments of the present disclosure may be realized by software (e.g., a program) including one or more instructions stored in a storage medium (e.g., the memory 165 in FIG. 2) (e.g., an internal memory or external memory,) that can be read by a machine (e.g., the integrated monitoring apparatus). For example, a processor (e.g., the processor 167) of the machine (e.g., the integrated monitoring apparatus 160) may invoke and execute at least one instruction among the stored one or more instructions from the storage medium. Accordingly, the machine operates to perform at least one function in accordance with the invoked at least one command. The one or more instructions may include code generated by a compiler or code executable by an interpreter. The machine-readable storage medium may be provided in the form of a non-transitory storage medium. Here, when a storage medium is referred to as “non-transitory,” it can be understood that the storage medium is tangible and does not include a signal (for example, electromagnetic waves), but rather that data is semi-permanently or temporarily stored in the storage medium.

According to one embodiment, the methods according to the various embodiments disclosed herein may be provided in a computer program product. The computer program product may be traded between a seller and a buyer as a product. The computer program product may be distributed in the form of a machine-readable storage medium (e.g., a compact disc read only memory (CD-ROM)) or may be distributed directly between two user devices (e.g., smartphones) through an application store (e.g., Play Store™), or online (e.g., downloaded or uploaded). In the case of online distribution, at least a portion of the computer program product may be stored at least semi-permanently or may be temporarily generated in a machine-readable storage medium, such as a memory of a server of a manufacturer, a server of an application store, or a relay server.

Components according to various embodiments of the disclosure may be implemented in the form of software or hardware, such as a digital signal processor (DSP), an FPGA or an ASIC, and may perform predetermined functions. The “elements” are not limited to being software or hardware. Each of the elements may be configured to be stored in a storage medium capable of being addressed and configured to execute one or more processors. For example, the elements may include elements such as software elements, object-oriented software elements, class elements, and task elements, processes, functions, attributes, procedures, subroutines, segments of program code, drivers, firmware, microcode, circuits, data, databases, data structures, tables, arrays, and variables.

According to the various embodiments, each of the above-described elements (e.g., a module or a program) may include a singular entity or a plurality of entities. According to various embodiments, one or more of the above-described elements or operations may be omitted, or one or more other elements or operations may be added. Alternatively, or additionally, a plurality of elements (e.g., modules or programs) may be integrated into one element. In this case, the integrated element may perform one or more functions of each of the plurality of elements in the same manner or a similar manner as the corresponding component did prior to integration. According to various embodiments, operations performed by a module, program, or other elements may be executed sequentially, in parallel, repeatedly, or heuristically, or one or more of the operations may be executed in a different order, or omitted, or one or more other operations may be added.

As is apparent from the above, according to various embodiments disclosed in this document, an abnormal crowd movement flow can be monitored based on wireless channel access information. In addition, various effects that are directly or indirectly identified through this document can be provided.

What is claimed is:

1. An integrated monitoring apparatus comprising:
a communication module; and
a processor functionally connected to the communication module,
wherein the processor acquires connection information related to base station devices to which user terminals in a monitoring space are connected among a plurality of base station devices in the monitoring space through the communication module,
identifies whether at least one abnormal situation from among an abnormal movement flow or an abnormal behavior of the user terminals occurs, based on a change in the connection information, and
upon detecting an occurrence of the abnormal situation, determines whether to respond to the abnormal situation based on a location of a target terminal related to the occurrence of the abnormal situation among the user terminals.

2. The integrated monitoring apparatus of claim 1, wherein the processor acquires an authentication code from the user terminal at an entrance to the monitoring space to distinguish the user terminals in the monitoring space.

3. The integrated monitoring apparatus of claim 2, wherein the processor, in response to requests of the user terminals, performs a user authentication and provides the authentication code related to an admission ticket of the monitoring space to the user terminals.

4. The integrated monitoring apparatus of claim 2, wherein the processor, through the communication module, acquires the authentication code and an admission time of the monitoring space from a kiosk that acquires the authentication code of the user terminals at the entrance.

5. The integrated monitoring apparatus of claim 2, wherein the processor provides a designated application configured to transmit the authentication code to the user terminals in the monitoring space at the entrance, and
blocks access to a data communication channel for external base station devices other than the plurality of base station devices in the monitoring space through the designated application.

6. The integrated monitoring apparatus of claim 1, wherein the connection information includes terminal IDs of the user terminals, IDs of base stations, to which the user terminals are connected, within the monitoring space, and connection time information of the user terminals.

7. The integrated monitoring apparatus of claim 6, wherein the processor calculates the number of user terminals connected to each of the base station devices, and movement speeds and movement directions of the user terminals based on the change in the connection information, and
detects the abnormal movement flow based on the number of user terminals connected to each of the base station devices, the movement speeds, and the movement directions.

8. The integrated monitoring apparatus of claim 1, wherein the processor detects at least one of: a case in which there is an overcrowded base station among the plurality of base station devices to which user terminals that satisfy a second reference value or more are connected; or a case in which the number of user terminals moving in the same direction among the user terminals satisfies a first reference value or more and a moving speed of the users terminals is a threshold speed or more, as the abnormal movement flow.

9. The integrated monitoring apparatus of claim 1, wherein the processor, among the plurality of base station devices, requests location information of the target terminal from a base station device to which the target terminal is connected and at least one neighboring base station device, acquires terminal location information calculated by each of the base station devices to which the target terminal is connected and the at least one neighboring base station device, and determines a location of the target terminal by integrating the terminal location information.

10. The integrated monitoring apparatus of claim 1, wherein the processor determines a density within a target area in which the target terminals are present based on the locations of the target terminals and determines whether to respond to the detected abnormal movement flow based on a duration during which the density is equal to or greater a threshold density.

11. The integrated monitoring apparatus of claim 1, wherein the processor outputs at least one response command related to deployment of crowd control personnel or an opening of an entrance according to a risk level of the detected abnormal movement flow.

12. The integrated monitoring apparatus of claim 1, wherein the processor, when it is identified based on a change in the connection information that user terminals that satisfy a threshold number or more among the user terminals are connected to one of the plurality of base station devices for a threshold time or longer, identifies location information of the connected user terminals, and
determines a case in which a distance between the connected user terminals is within a threshold distance, or a case in which changes in locations of the connected user terminals relative to each other is less than a first threshold change rate corresponding to a slight location change or is greater than a second threshold change rate corresponding to a rapid location change, as the abnormal behavior, and
determines to deploy crowd control personnel to the locations of the connected user terminals.

13. The integrated monitoring apparatus of claim 1, wherein the processor tracks a location of a user terminal connected to a base station device adjacent to an entrance or an emergency exit of the monitoring space among the plurality of base station devices through the communication module, and
determines to deploy crowd control personnel to the tracked location of the user terminal when repeated approaches to and departures from the entrance are identified within a threshold time based on the tracked location of the user terminal.

14. The integrated monitoring apparatus of claim 1, wherein the processor acquires closed-circuit television (CCTV) footage of the monitoring space through the communication module, and learns detection and response to the abnormal movement flow/abnormal behavior by an artificial intelligence model using the CCTV footage related to the detected abnormal movement flow/abnormal behavior, the change in the connection information and abnormal situation confirmation result data according to the detected abnormal movement flow/abnormal behavior, and updates the artificial intelligence model.

15. A user terminal comprising:
a communication module;
a memory storing instructions related to execution of a designated application; and
a processor functionally connected to the memory,
wherein the processor executes the instructions to:
allow the communication module to connect to at least one base station device among a plurality of base station devices within a monitoring space and block connection with other base station devices; and
when an authentication code is transmitted to an external electronic device at an entrance to the monitoring space through the designated application, determine that the user terminal is entered the monitoring space.

16. An integrated monitoring method which is performed by at least one processor, comprising:
acquiring connection information related to base station devices to which user terminals in a monitoring space are connected among a plurality of base station devices in the monitoring space;
identifying whether at least one abnormal situation from among an abnormal movement flow or an abnormal behavior of the user terminals occurs, based on a change in the connection information; and
upon detecting an occurrence of the abnormal situation, performing a response to the abnormal situation based on a location of a target terminal related to the occurrence of the abnormal situation among the user terminals.

17. The integrated monitoring method of claim 16, wherein the acquiring of the connection information includes:
in response to requests of the user terminals, performing a user authentication and providing an authentication code related to an admission ticket of the monitoring space to the user terminals; and
acquiring the authentication code from the user terminal at an entrance to the monitoring space to distinguish the user terminals in the monitoring space.

18. The integrated monitoring method of claim 16, wherein the acquiring of the connection information includes:
providing a designated application configured to transmit an authentication code to the authenticated user terminals in the monitoring space at the entrance; and
blocking access to a data communication channel for external base station devices other than the plurality of base station devices in the monitoring space through the designated application.

19. The integrated monitoring method of claim 16, wherein the detecting of the occurrence of the abnormal situation includes detecting at least one of: a case in which there is an overcrowded base station among the plurality of base station devices to which user terminals that satisfy a second threshold or more are connected;
or a case in which the number of user terminals moving in the same direction among the user terminals is a first threshold or more and a moving speed of the user terminals is a threshold speed or more, as the abnormal movement flow.

20. The integrated monitoring method of claim 16, further comprising:
acquiring closed-circuit television (CCTV) footage of the monitoring space;
learning detection and response to the abnormal movement flow/abnormal behavior by an artificial intelligence model using the CCTV footage at a time when the identified abnormal movement flow/abnormal behavior occurs, the change in the connection information, and abnormal situation confirmation result data according to the detected abnormal movement flow/abnormal behavior; and
updating the artificial intelligence model.
